(19) United States
(12) Patent Application Publication
(10) Pub. No.: US 2016/0372764 A1
(43) Pub. Date: Dec. 22, 2016

(54) METAL-AIR BATTERY APPARATUS AND OPERATION METHOD THEREOF

(71) Applicant: Samsung Electronics Co., Ltd., Suwon-si (KR)

(72) Inventors: Hyunjin KIM, Suwon-si (KR); Jeongsik KO, Seongnam-si (KR); Dongmin IM, Seoul (KR)

(21) Appl. No.: 15/053,389

(22) Filed: Feb. 25, 2016

(30) Foreign Application Priority Data
Jun. 17, 2015 (KR) 10-2015-0086176

(51) Int. Cl. H01M 8/04007; H01M 10/65; H01M 8/10; H01M 10/05; H01M 12/08; H01M 8/04701

(52) U.S. Cl. CPC H01M 8/04007; H01M 12/08; H01M 8/04731; H01M 8/10; H01M 10/05; H01M 10/65

(57) ABSTRACT

A metal-air battery apparatus includes a positive electrode, a negative electrode on the positive electrode, an ion conductive layer between the positive electrode and the negative electrode, and a temperature control unit which controls temperatures of the positive electrode and the negative electrode. The metal-air battery apparatus may further include a monitoring unit which monitors an internal condition of the metal-air battery apparatus, and the temperature of at least one of the positive electrode and negative electrode may be controlled by monitoring the internal condition of the metal-air battery apparatus.

### CROSS-REFERENCE TO RELATED APPLICATION

This application claims priority to Korean Patent Application No. 10-2015-0086176, filed on Jun. 17, 2015, and all the benefits accruing therefrom under 35 U.S.C. §119, the content of which in its entirety is herein incorporated by reference.

### BACKGROUND

1. Field

The disclosure relates to a metal-air battery apparatus and an operation method thereof, and more particularly, to a metal-air battery apparatus including a temperature control unit.

2. Description of the Related Art

A metal-air battery typically includes a negative electrode, capable of occlusion and emission of metal ions, such as lithium (Li), and a positive electrode capable of oxidation and reduction of oxygen in the air, and a metal ion conductive medium between the positive electrode and the negative electrode.

In the metal-air battery, metal ions from the negative electrode and oxygen in the air on the positive electrode side react with one another and generate metallic oxide during a discharging process. The generated metallic oxide is reduced to metal ions and air or oxygen during a charging process. Thus, both charging and discharging of the metal-air battery are possible.

Since oxygen, a positive electrode active material, is available from the air, it may not be necessary to fill the positive electrode active material into the metal-air battery. Thus, the metal-air battery may, theoretically, have a larger capacity than a secondary battery using a solid positive electrode active material.

Also, a Li-air battery uses air in the atmosphere as the positive electrode active material, and thus, may have a very high energy density. Accordingly, the Li-air battery has received a lot of attention as a next-generation battery.

### SUMMARY

A feature of the disclosure relates to a metal-ion battery apparatus including a temperature control unit.

Another feature of the disclosure relates to an operation method of the metal-ion battery apparatus.

An exemplary embodiment of a metal-air battery apparatus includes a positive electrode, a negative electrode on the positive electrode, an ion conductive layer between the positive electrode and the negative electrode; and the temperature control unit which controls temperatures of the positive electrode and the negative electrode.

In an exemplary embodiment, the temperature control unit may include a monitoring element which monitors an internal condition of the metal-air battery apparatus.

In an exemplary embodiment, the metal-air battery apparatus may further include a monitoring unit spaced apart from the temperature control unit, where the monitoring unit monitors an internal condition of the metal-air battery apparatus.

In an exemplary embodiment, the temperature control unit may include a positive electrode temperature control unit connected to the positive electrode; and a negative electrode temperature control unit connected to the negative electrode.

In an exemplary embodiment, the positive electrode temperature control unit may be in a direct contact with the positive electrode and the negative electrode temperature control unit may be in a direct contact with the negative electrode.

In an exemplary embodiment, the metal-air battery apparatus may further include a positive electrode thermally conductive layer in the positive electrode, where the positive electrode thermally conductive layer may be connected to the positive electrode temperature control unit.

In an exemplary embodiment, the metal-air battery apparatus may further include a positive electrode thermally conductive layer on the positive electrode, where the positive electrode thermally conductive layer may be connected to the positive electrode temperature control unit.

In an exemplary embodiment, the metal-air battery apparatus may further include a negative electrode thermally conductive layer on the positive electrode, where the negative electrode thermally conductive layer may be connected to the negative electrode temperature control unit.

An exemplary embodiment of an operation method of the metal-air battery apparatus includes presetting a temperature of at least one of a positive electrode and a negative electrode, monitoring an internal condition of the metal-air battery apparatus, and changing a driving temperature of the positive electrode or the negative electrode based on a result of the monitoring the internal condition of the metal-air battery apparatus and whether the temperature of the positive electrode or the negative electrode is different from a preset temperature of the positive electrode or the negative electrode.

An exemplary embodiment of an operation method of the metal-air battery apparatus includes a first operation of presetting a temperature of at least one of a positive electrode and a negative electrode; a second operation of changing the temperature of the at least one of the positive electrode and the negative electrode; a third operation of monitoring the internal condition of the metal-air battery apparatus; and a fourth operation of determining whether to change the temperature of the at least one of the positive electrode and the negative electrode based on the internal condition of the metal-air battery apparatus.

### BRIEF DESCRIPTION OF THE DRAWINGS

These and/or other features of embodiments of the invention will become apparent and more readily appreciated from the following description of the exemplary embodiments, taken in conjunction with the accompanying drawings, in which:

FIG. 1 is a cross-sectional view of a metal-air battery apparatus according to an exemplary embodiment of the inventive concept;

FIG. 2 is a cross-sectional view of a metal-air battery apparatus according to an alternative exemplary embodiment of the inventive concept;

FIG. 3 is a drawing of a metal-air battery apparatus according to another alternative exemplary embodiment of the inventive concept;

FIG. 4 is a drawing of a metal-air battery apparatus according to another alternative exemplary embodiment of the inventive concept;

FIG. 5 is a flow chart of an operation method of a metal-air battery apparatus according to an exemplary embodiment of the inventive concept;

FIG. 6 is a flow chart illustrating an algorithm for performing the operation method of the metal-air battery apparatus via continuous monitoring; and

FIG. 7 is a graph of an energy density of the metal-air battery apparatus with respect to charging/discharging cycles at a high temperature and a low temperature.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain features. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

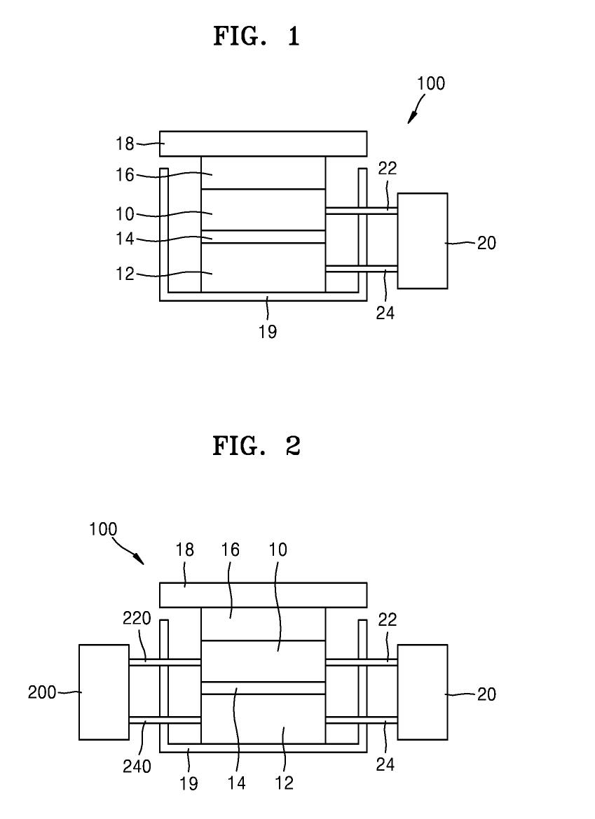

FIG. 1 is a cross-sectional view of a metal-air battery apparatus 100 according to an exemplary embodiment of the inventive concept.

Referring to FIG. 1, an exemplary embodiment of a metal-air battery apparatus 100 may include a positive electrode 10 capable of oxidation and reduction of oxygen in the air and a negative electrode 12 capable of occlusion and emission of metal ions. The metal-air battery apparatus 100 may further include an ion conductive layer 14 between the positive electrode 10 and the negative electrode 12. The metal-air battery apparatus 100 may further include a positive electrode collector 16 and a diffusive layer 18, which are disposed on a surface (e.g., over an upper surface) of the positive electrode 10, and a negative collector 19 disposed on a surface (e.g., below a lower surface) of the negative electrode 12. The positive electrode 10, the negative electrode 12, the ion conductive layer 14, the diffusive layer 18 and positive and negative electrode collectors 16, 19 may collectively define a unit cell structure of the metal-air battery, and the unit cell structure may have a structure wrapped by a separate pouch, etc.

In such an embodiment, the positive electrode 10 and the negative electrode 12 may each be connected to a temperature control unit 20. The temperature control unit 20 may control a temperature of the positive electrode 10 using a positive electrode temperature control unit 22 directly connected to the positive electrode 10. In such an embodiment, the temperature control unit 20 may control the temperature of the negative electrode 12 using a negative electrode temperature control unit 24 directly connected to the negative electrode 12. Temperature control of the positive electrode 10 or the negative electrode 12 by the temperature control unit 20 may include both decreasing and increasing the temperature of the positive electrode 10 or the negative electrode 12 under a current condition of the metal-air battery apparatus 100 or an environment thereof. The temperature control unit 20 may, individually and independently, control the temperature of the positive electrode 10 and the temperature of the negative electrode 12. In one exemplary embodiment, for example, the temperature of the negative electrode 12 may be decreased or increased while the temperature of the positive electrode 10 is maintained as is, and the temperature of the positive electrode 10 may be decreased or increased while the temperature of the negative electrode 12 is maintained as is. In such an embodiment, the temperature of the negative electrode 12 may be decreased while the temperature of the positive electrode 10 is increased, or the temperature of the negative electrode 12 may be increased while the temperature of the positive electrode 10 is decreased.

In an exemplary embodiment, the temperature control unit 20 may control the temperature of the positive electrode 10 or the negative electrode 12 to a high temperature or a low temperature. The high temperature may be the temperature in a range of about 50° C. to about 70° C., and the low temperature may be the temperature in a range of about 20° C. to about 40° C. The temperature control unit 20 may maintain the positive electrode 10 at one of the high temperature or the low temperature through the positive electrode temperature control unit 22, and may maintain the negative electrode 12 in one temperature range corresponding to the high temperature or the low temperature through the negative electrode temperature control 24. The positive electrode temperature control unit 22 may be in a direct contact with the positive electrode 10, and the negative electrode temperature control unit 24 may be in a direct contact with the negative electrode 12.

The temperature control unit 20 may include a monitoring element that measures an internal condition of the metal-air battery apparatus 100 to control temperatures of the positive electrode 10 and the negative electrode 12. The temperature of the positive electrode 10 may be measured through the positive electrode temperature control unit 22, and the temperature of the negative electrode 12 may be measured through the negative electrode temperature control unit 24. In such an embodiment, gas compositions inside the metal-air battery apparatus 100 may be further measured.

When the metal-air battery apparatus is operating, and the positive electrode 10 and the negative electrode 12 are maintained at high temperatures, high ion conductivity may be maintained, which may be desirable for a high output operation. When the positive electrode 10 and the negative electrode 12 are maintained at low temperatures, an operation may be obtained with an output relatively lower than that in case of maintaining high temperatures; however, an electrolyte side reaction may be deterred and a relatively continuous output may be maintained even with an increase in charging/discharging cycles.

FIG. 2 is a cross-sectional view of a metal-air battery apparatus according to an alternative exemplary embodiment of the inventive concept.

Referring to FIG. 2, an exemplary embodiment of the metal-air battery apparatus 100 may include the positive electrode 10 and the negative electrode 12, and further include the ion conductive layer 14 between the positive electrode 10 and the negative electrode 12. In such an embodiment, the metal-air battery apparatus 100 may further include the positive electrode collector 16 and the diffusive layer 18, which are over the positive electrode 10, and the negative electrode collector 19 on the negative electrode 12. The positive electrode 10 and the negative electrode 12 may each be connected to the temperature control unit 20. The temperature control unit 20 may control the temperature of the positive electrode 10 using the positive electrode temperature control unit 22 directly connected to the positive electrode 10, and may control the temperature of the negative electrode 12 using the negative electrode temperature control unit 24 directly connected to the negative electrode 12. The positive electrode temperature control unit 22 is in a direct contact with the positive electrode 10 and the temperature control unit 20 may control the temperature of the positive electrode 10. In such an embodiment, the negative electrode temperature control unit 24 may extend from the temperature control unit 20 and in a direct contact with the negative electrode 12. The temperature control unit 20 may control the temperature of the positive electrode 10 or the negative electrode 12 at one of the high temperature and the low temperature; herein, the high temperature may be a temperature in a range of about 50° C. to about 70° C. and the low temperature may be a temperature in a range of about 20° C. to about 40° C.

Such an embodiment of the metal-air battery apparatus 100, as illustrated in FIG. 2, may further include a monitoring unit 200 that monitors and measures an internal condition of the metal-air battery apparatus 100 to control temperatures of the positive electrode 10 and the negative electrode 12. The monitoring unit 200 may include a first measuring unit 220 and a second measuring unit 240. The first measuring unit 220 may connect the monitoring unit 200 and the positive electrode 10, and may be directly connected to or contact the positive electrode 10. The second measuring unit 240 may connect the monitoring unit 200 and the negative electrode 12, and may be directly connected to or contact the negative electrode 12. In such an embodiment of the metal-air battery apparatus, as illustrated in FIG. 2, the monitoring unit 200 is spaced apart from, or disposed outside of, the temperature control unit 20. The first measuring unit 220 and the second measuring unit 240 of the monitoring unit 200 may not only measure temperatures of the positive electrode 10 and the negative electrode 12 but also monitor electrolyte conditions, kinds of generated gas compositions, charging/discharging profiles, etc. inside the metal-air battery apparatus 100.

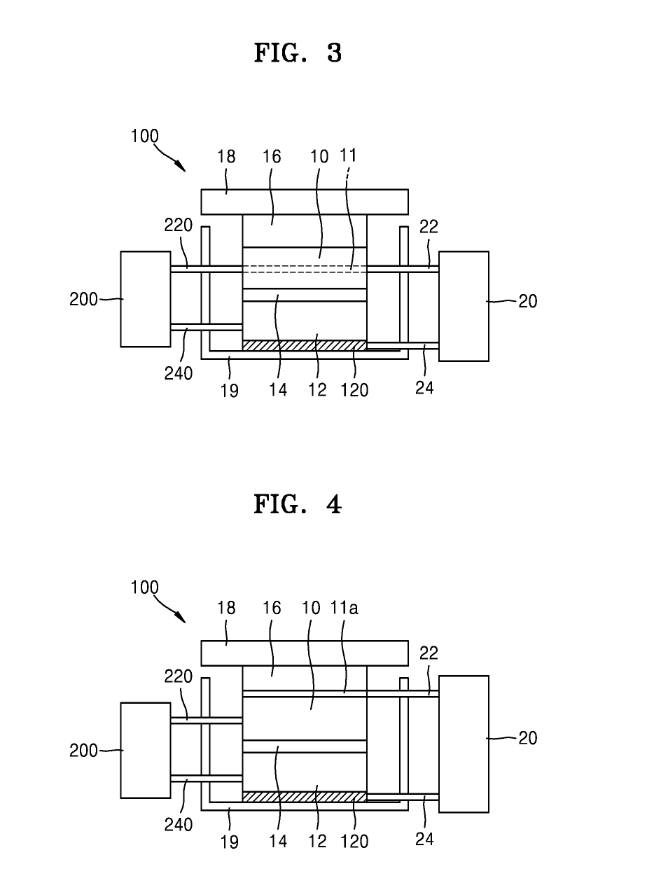

FIG. 3 is a drawing of a metal-air battery apparatus according to another alternative exemplary embodiment of the invention.

Referring to FIG. 3, an exemplary embodiment of the metal-air battery apparatus 100 may include the positive electrode 10 and the negative electrode 12, and further include an ion conductive layer 14 between the positive electrode 10 and the negative electrode 12. The metal-air battery apparatus 100 may further include the positive electrode collector 16 and the diffusive layer 18, which are over the positive electrode 10, and the negative electrode collector 19 disposed on the negative electrode 12.

The positive electrode 10 and the negative electrode 12 may each be connected to the temperature control unit 20. The temperature control unit 20 may control the temperature of the positive electrode 10 using the positive electrode temperature control unit 22 directly connected to the positive electrode 10, and may control the temperature of the negative electrode 12 using the negative electrode temperature control unit 24 directly connected to the negative electrode 12. In such an embodiment, as shown in FIG. 3, the positive electrode temperature control unit 22 may not be directly connected to the positive electrode 10 but may be connected to a positive electrode thermally conductive layer 11 disposed inside the positive electrode 10. The positive electrode thermally conductive layer 11 may control the temperature of the positive electrode 10 under a control of the temperature control unit 20, by transferring, to the positive electrode 10, a heat transferred through the positive electrode temperature control unit 22, or by emitting the heat from the positive electrode 10 to the positive electrode temperature control unit 22. In such an embodiment, the negative electrode thermally conductive layer 120 may control the temperature of the negative electrode 12 under the control of the temperature control unit 20, by transferring, to the negative electrode 12, the heat transferred through the negative electrode temperature control unit 24, or by emitting the heat from the negative electrode 12 to the negative electrode temperature control unit 24.

FIG. 4 is a drawing of a metal-air battery apparatus according to another alternative exemplary embodiment of the invention.

Referring to FIG. 4, in an exemplary embodiment of a metal-air battery, a positive electrode thermally conductive layer 11a may be between the positive electrode 10 and the positive electrode collector 16. One side of the positive electrode thermally conductive layer 11a may be in a direct contact with the positive electrode 10, and the other side of the positive electrode thermally conductive layer 11a may be in a direct contact with the positive electrode collector 16. The positive electrode thermally conductive layer 11a may control the temperature of the positive electrode 10 by transferring, to the positive electrode 10, the heat transferred through the positive electrode temperature control unit 22 from the temperature control unit 20, or by emitting the heat from the positive electrode 10 to the positive electrode temperature control unit 22.

The positive electrode 10 may include a conductive material capable of oxidation or reduction of oxygen in the air and there is no limit in selection of materials. In one exemplary embodiment, for example, the positive electrode 10 may include a carbon-based material, graphite, graphene, carbon black, or carbon fiber. In an alternative exemplary embodiment, the conductive material such as a metal fiber and a metal mesh or a metal powder of copper, silver, nickel, aluminum, etc. may be used as a positive electrode active material. In an exemplary embodiment, the positive electrode 10 may include an organic conductive material. Such conductive materials may be used; individually or as a mixture. In such an embodiment, the positive electrode 10 may include a binder of a thermoplastic resin, a thermosetting resin, etc., and may include an ion conductive polymer electrolyte. In such an embodiment, a catalyst for oxidation or reduction of oxygen may be added to the positive electrode 10. Other positive electrode materials used in the metal-air battery apparatus may be used without limit. The positive electrode 10 may be formed by preparing a mixture through mixing the catalyst for oxidation or reduction of oxygen and the binder with conductive materials, adding a solvent to this mixture, coating the mixture onto one side (or one surface) or both sides (or opposing surfaces) of the positive electrode thermally conductive layer 11a, and drying up the mixture. The positive electrode thermally conductive layer 11a may be a metal material layer having a mesh-like shape.

The negative electrode 12 may include a lithium metal thin membrane, and may further include other negative electrode active materials excluding lithium metal. The negative electrode 12 may be manufactured by using negative electrode active material composites including a negative electrode active material, a conductive agent, a binder and a solvent. The negative electrode 12 may be manufactured in a form of an alloy, a compound or a mixture by additionally including other negative electrode active material along with lithium metal. Other negative electrode active materials excluding Lithium may include at least one of metals formable with lithium as alloys, transition metal oxides, non-transition metal oxides, and carbon-based materials. In one exemplary embodiment, For example, transition metal oxides may include lithium titanium oxide, vanadium oxide, lithium vanadium oxide, etc. Carbon-based materials may include crystalline structure carbon, amorphous carbon or their compounds. The negative electrode 12 may be formed by directly coating the negative electrode active composite onto the negative electrode collector 19 or the negative electrode thermally conductive layer 120, after manufacturing a negative electrode active composite. Alternatively, after casting a negative electrode active material layer in a separate supporting fixture, the negative electrode 12 may be formed by bonding the negative electrode active material layer peeled off from the supporting fixture onto the negative electrode collector 19 or the negative electrode thermally conductive layer 120.

The ion conductive layer 14 may be an active metal ion conductive layer having a conductivity to an active metal ion and may include an ion conductive solid membrane. The ion conductive solid membrane may be a composite membrane including a porous organic membrane having pores and an ion conductive polymer electrolyte inside pores. The porous organic membrane may include, for example, a porous film including a polymer non-woven fabric such as non-woven fabric made of polypropylene, non-woven fabric made of polyimide, and non-woven fabric made of polyphenylene sulfide, and an olefin resin such as polyethylene, polypropylene, polybutene, and polyvinylchloride; however, it is not limited thereto and any material usable for the porous organic membrane in the art may be utilized. The ion conductive layer 14 may have a single layer structure or a multilayer structure. In an exemplary embodiment, where the ion conductive layer 14 has a multilayer structure, the multilayer structure may include a composite membrane capable of blocking gas and moisture, and a polymer electrolyte membrane. In such an embodiment, a separator may further be between the positive electrode 10 and the negative electrode 12. In an exemplary embodiment, the ion conductive layer 14 may function as the separator, and the separator may be selectively spaced apart from the ion conductive layer 14. In such an embodiment, a separator conventionally used in the metal-air battery apparatus 100 may be used without limit. In one exemplary embodiment, for example, the separator may include a porous film made of a polymer non-woven fabric such as non-woven fabric made of polypropylene and polyphenylene sulfide, and an olefin resin such as polyethylene and polypropylene.

The positive electrode collector 16 and the negative electrode collector 19 may use metallic materials without limit, as long as metallic materials have a high conductivity. In one exemplary embodiment, for example, the positive electrode collector 16 and the negative electrode collector 19 may include materials such as Cu, Au, Pt, Ag, Ni, and Fe; however, it is not limited thereto. In an exemplary embodiment, the positive electrode collector 16 and the negative electrode collector 19 may include not only metals but also materials such as conductive metal oxides and conductive polymers. The positive electrode collector 16 or the negative electrode collector 19 may have a structure including a non-conductive material coated on a surface of the positive electrode collector 16 or the negative electrode collector 19. The positive electrode collector 16 and the negative electrode collector 19 may have a flexibility of being bendable and have an elasticity of recovering back to original shapes.

The diffusive layer 18 may provide an air supply path for supplying oxygen in the air to the positive electrode 10. The diffusive layer 18 may include a carbon fiber-based material such as a carbon paper. In an exemplary embodiment, the diffusive layer 18 may be a porous membrane including organic compounds. The diffusive layer 18 may include a polymer of at least one of a homopolymer, a block copolymer and a random copolymer.

A term “air” used in the specification may include not only the air existing in the atmosphere but also a gas mixture including oxygen, and a pure oxygen gas.

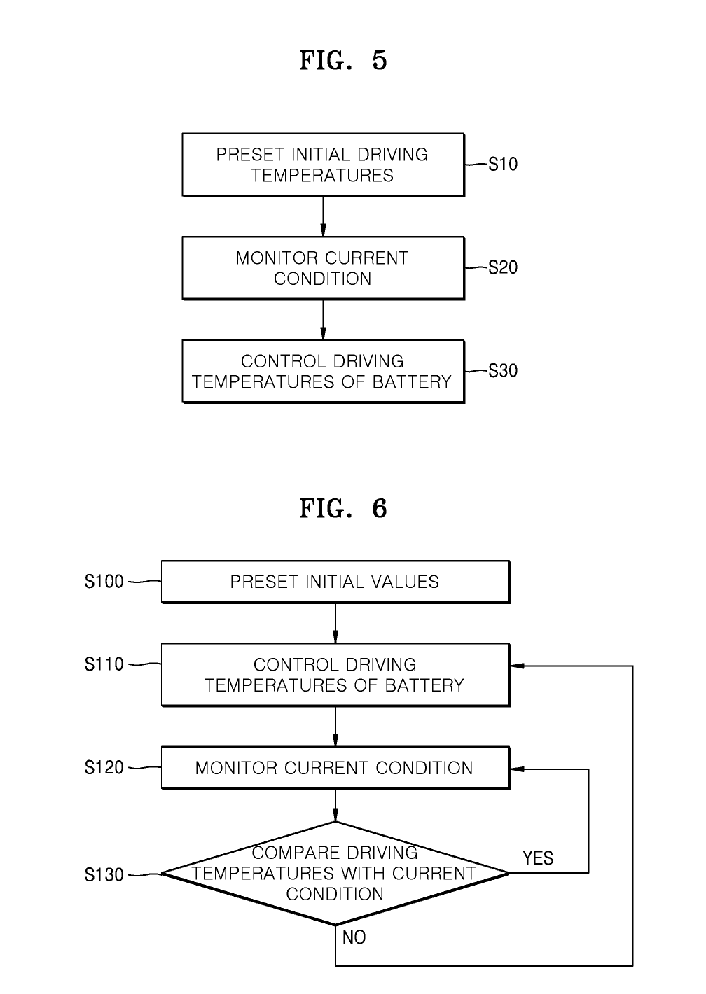

FIG. 5 is a flow chart of an operation method of a metal-air battery apparatus according to an exemplary embodiment of the invention.

Referring to FIG. 5, in an embodiment of an operation method of a metal-air battery apparatus, initial driving temperatures of a positive electrode 10 and a negative electrode 12 of the metal air battery apparatus may be preset S10 before operating the metal-air battery apparatus. As described above, driving temperatures of the positive electrode 10 and the negative electrode 12 may each be preset at the high temperature or the low temperature. The high temperature may be a temperature in a range of about 50° C. to about 70° C. When the metal-air battery apparatus is operated in the temperature range of high temperatures of the positive electrode 10 and the negative electrode 12, the high ion conductivity may be maintained and the high output operation may be possible. The low temperature may be a temperature in a range of about 20° C. to about 40° C. When the metal-air battery apparatus is operated in the temperature range of the low temperature of the positive electrode 10 and the negative electrode 12, the electrolyte side reaction may be deterred and the relatively stable output may be maintained despite an increase in charging/discharging cycles.

The temperatures of the positive electrode 10 and the negative electrode 12 may each preset at the high temperature or at the low temperature, independently of each other. In such an embodiment, the positive electrode 10 may be preset at the high temperature and the negative electrode 12 may be preset at the low temperature. In such an embodiment, the positive electrode 10 may be preset at the low temperature and the negative electrode 12 may be preset at the high temperature. In such an embodiment, one of the positive electrode 10 and the negative electrode 12 may be selectively preset at either the high temperature or the low temperature. In one exemplary embodiment, for example, the negative electrode 12 only may be preset at either the high temperature or the low temperature. The preset temperatures of the positive electrode 10 and the negative electrode 12 may be default values which are empirically preset, or values set or selected by a user. In an exemplary embodiment where the preset temperatures of the positive electrode 10 and the negative electrode 12 are values set or selected by a user, the user may arbitrarily select the preset temperatures each time the metal-air battery apparatus is operated.

Then, the internal condition of the metal-air battery apparatus 100 may be monitored S20. A monitoring may be performed at the temperature control unit 20, and may be separately performed by the monitoring unit 200. In such a process of monitoring, temperatures of the positive electrode 10 and the negative electrode 12 may be measured, and electrolyte conditions, generated gas compositions, charging/discharging profiles, etc. inside the metal-air battery apparatus 100 may be further monitored.

When there is a difference between a preset temperature and a monitored result of the internal condition of the metal-air battery apparatus 100, the driving temperature of either the positive electrode 10 or the negative electrode 12 inside the metal-air battery apparatus 100 may be controlled S30. The positive electrode temperature control unit 22 and the negative electrode temperature control unit 24, which are connected to both the positive electrode 10 and the negative electrode 12, respectively, may be used to control driving temperatures of the positive electrode 10 and the negative electrode 12 of the metal-air battery apparatus 100. Heating or cooling of the positive electrode 10 and the negative electrode 12 by the temperature control unit 20 may be performed by using a high frequency induction heating method or a thermoelectric effect phenomenon of metals or semiconductors; however, it is not limited thereto and various temperature control methods may be used without limit.

FIG. 6 is a flow chart illustrating an algorithm, in which the operation method of the metal-air battery apparatus 100 may be performed via continuous monitoring. As shown in FIG. 6, in an exemplary embodiment of the operation method of the metal-air battery apparatus 100, an operation control of the metal-air battery apparatus 100 may be possible via continuous monitoring of the internal condition of the metal-air battery apparatus 100.

Referring to FIG. 6, in such an embodiment, when the metal-air battery apparatus 100 is operated, initial driving temperatures of the positive electrode 10 and the negative electrode 12 may be preset S100. Driving temperatures of the positive electrode 10 and the negative electrode 12 may each be independently preset at the high temperature or the low temperature. In one exemplary embodiment, for example, temperatures of the positive electrode 10 and the negative electrode 12 may be simultaneously preset at either the high temperature or the low temperature, but not being limited thereto. In an alternative exemplary embodiment, the positive electrode 10 may be preset at the high temperature and the negative electrode 12 may be preset at the low temperature, or the positive electrode 10 may be preset at the low temperature and the negative electrode 12 may be preset at the high temperature. In such an embodiment, one of the positive electrode 10 and the negative electrode 12 may be selectively preset at either the high temperature or the low temperature. Presetting temperatures of the positive electrode 10 and the negative electrode 12 may be default values based on a default setting, e.g., empirically preset, or values set or selected by a user, e.g., temperatures arbitrarily selected by a user each time the metal-air battery apparatus 100 is operated.

In such an embodiment, temperatures of the positive electrode 10 and the negative electrode 12 may each be controlled based on preset temperatures for the positive electrode 10 and the negative electrode 12 S110. Temperatures of the positive electrode 10 and the negative electrode 12 may be controlled by using the positive electrode temperature control unit 22 and the negative electrode temperature control unit 24 which are connected to the positive electrode 10 and the negative electrode 12 from the temperature control unit 20, respectively.

In such an embodiment, the internal condition of the metal-air battery apparatus 100 may be monitored S120. The monitoring of the metal-air battery apparatus 100 may be performed by the temperature control unit 20 as illustrated in FIG. 1, or separately by the monitoring unit 200 as illustrated in FIG. 2. In such a process of monitoring, temperatures of the positive electrode 10 and the negative electrode 12 may be measured, and electrolyte conditions, generated gas compositions, charging/discharging profiles, etc. inside the metal-air battery apparatus 100 may further be monitored.

Then, after comparing the internal condition monitored in the operation S120 of the metal-air battery apparatus 100 with driving temperatures of the positive electrode 10 and the negative electrode 12, whether to maintain current temperatures of the positive electrode 10 and the negative electrode 12 as they are may be determined S130. In such an embodiment, conditions of the metal-air battery apparatus 100 may include temperatures of the positive electrode 10 and the negative electrode 12; however, conditions of the metal-air battery apparatus 100 may include conditions other than temperatures such as conditions of products due to the electrolyte side reaction and conditions of deposits formed on a surface of the positive electrode 10. Accordingly, after comparing the current conditions of the metal-air battery apparatus 100 with driving temperatures, whether to change the temperature of at least one of the positive electrode 10 and the negative electrode 12 may be determined. In such an embodiment, it may be determined whether the temperature of at least one of the positive electrode 10 and the negative electrode 12 to be maintained at either the low temperature or the high temperature, or increased from the low temperature to the high temperature, or decreased from the high temperature to the low temperature.

When the internal condition of the metal-air battery apparatus 100 during operation thereof is determined as being stable and temperatures of the positive electrode 10 and the negative electrode 12 are to be maintained, the internal condition is considered to be “YES” and the monitoring at the operation S120 may be continuously performed. When the internal condition of the metal-air battery apparatus 100 during operation thereof is determined as being unstable and the temperature of at least one of the positive electrode 10 and the negative electrode 12 to be lowered from the high temperature to the low temperature, or the temperature of at least one of the positive electrode 10 and the negative electrode 12 to be increased from the low temperature to the high temperature to meet a high output demand, the internal condition is considered to be “NO” and the operation may proceed to the operation S110 of controlling the driving temperature.

Such an embodiment of the operation method described above with reference to FIG. 6 may be used when the metal-air battery apparatus 100 is continuously operating or the continuous monitoring is needed for the metal-air battery apparatus 100. Such an embodiment of the operation method described above with reference to FIG. 5 may be used when the metal-air battery apparatus 100 operates for a relatively short duration, or with initial presetting values only.

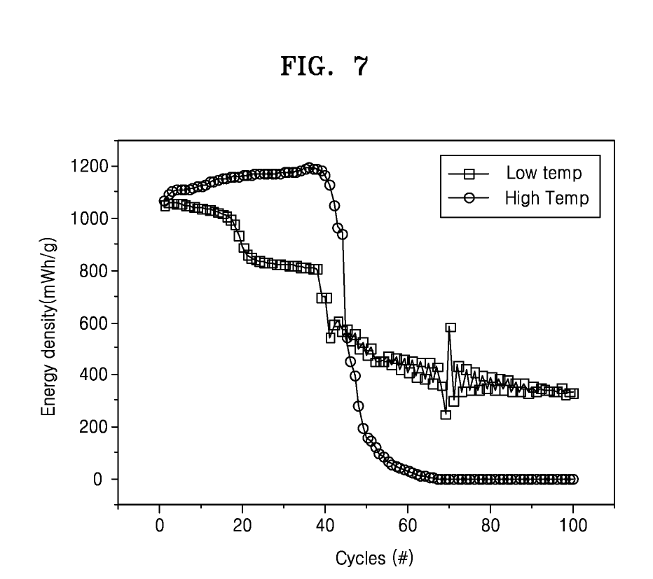

FIG. 7 is a graph of an energy density of the metal-air battery apparatus with respect to charging/discharging cycles at the high temperature and the low temperature.

Referring to FIG. 7, the energy density at a high temperature operation is larger than that at a low temperature operation, when charging/discharging cycles are low in a process of repeated charging/discharging operations at the high temperature and the low temperature. However, the energy density at the high temperature operation may abruptly decrease in a process of sufficiently repeated charging/discharging operations and increased cycles. On the other hand, the energy density may have a tendency of decreasing when charging/discharging is repeated at the low temperature operation; however, the energy density shows a continuous stability, unlike an abrupt decrease at the high temperature operation. Thus, a stable operation may be possible when the internal condition of the metal-air battery apparatus 100 is continuously monitored and, at the same time, the high temperature operation and the low temperature operation are properly changed.

In exemplary embodiment, as described herein, the metal-air battery apparatus 100 may include the temperature control unit 20 that controls driving temperatures of the positive electrode 10 and the negative electrode 12 of the metal-air battery apparatus 100. In such embodiment, at least one temperature of the positive electrode 10 and the negative electrode 12 may be controlled via real-time monitoring of the internal condition of the metal-air battery apparatus 100. Thus, the metal-air battery apparatus 100 with enhanced cyclic characteristics and stability may be provided.

It should be understood that exemplary embodiments described herein should be considered in a descriptive sense only and not for purposes of limitation, and it will be understood by those of ordinary skill in the art that various changes in form and details may be made therein without departing from the spirit and scope as defined by the following claims.

What is claimed is:

1. A metal-air battery apparatus comprising:
a positive electrode;
a negative electrode on the positive electrode;
an ion conductive layer between the positive electrode and the negative electrode; and
a temperature control unit which controls temperatures of the positive electrode and the negative electrode.

2. The metal-air battery apparatus of claim 1, wherein the temperature control unit comprises a monitoring element which monitors an internal condition of the metal-air battery apparatus.

3. The metal-air battery apparatus of claim 1, further comprising:
a monitoring unit spaced apart from the temperature control unit, wherein the monitoring unit monitors an internal condition of the metal-air battery apparatus.

4. The metal-air battery apparatus of claim 1, wherein the temperature control unit comprises:
a positive electrode temperature control unit connected to the positive electrode; and
a negative electrode temperature control unit connected to the negative electrode.

5. The metal-air battery apparatus of claim 4, wherein the positive electrode temperature control unit is in a direct contact with the positive electrode.

6. The metal-air battery apparatus of claim 4, wherein the negative electrode temperature control unit is in a direct contact with the negative electrode.

7. The metal-air battery apparatus of claim 4, further comprising:
a positive electrode thermally conductive layer in the positive electrode, wherein the positive electrode thermally conductive layer is connected to the positive electrode temperature control unit.

8. The metal-air battery apparatus of claim 4, further comprising:
a positive electrode thermally conductive layer on the positive electrode,
wherein the positive electrode thermally conductive layer is connected to the positive electrode temperature control unit.

9. The metal-air battery apparatus of claim 4, further comprising:
a negative electrode thermally conductive layer on the negative electrode,
wherein the negative electrode thermally conductive layer is connected to the negative electrode temperature control unit.

10. An operation method of a metal-air battery apparatus, the operation method comprising:
presetting a temperature of at least one of a positive electrode and a negative electrode;
monitoring an internal condition of the metal-air battery apparatus; and
changing a driving temperature of the positive electrode or the negative electrode upon determining, based on a result of the monitoring the internal condition of the metal-air battery apparatus and whether the temperature of the positive electrode or the negative electrode is different from a preset temperature of the positive electrode or the negative electrode.

11. The operation method of the metal-air battery apparatus of claim 10, wherein the driving temperature of the positive electrode or the negative electrode is in a range from about 20° C. to about 40° C. or in a range from about 50° C. to about 70° C.

12. An operation method of a metal-air battery apparatus, the method comprising:
a first operation of presetting a temperature of at least one of a positive electrode and a negative electrode;
a second operation of changing the temperature of the at least one of the positive electrode and the negative electrode;
a third operation of monitoring an internal condition of the metal-air battery apparatus; and
a fourth operation of determining whether to change the temperature of the at least one of the positive electrode and the negative electrode based on the internal condition of the metal-air battery apparatus.

13. The operation method of the metal-air battery apparatus of claim 12, wherein at least one of the second operation and the third operation is executed again after the fourth operation of determining whether to change the temperature of the at least one of the positive electrode and the negative electrode.

14. The operation method of the metal-air battery apparatus of claim 12, wherein the second operation, the third operation and the fourth operation are executed again when it is determined to change the temperature of the at least one of the positive electrode and the negative electrode.

15. The operation method of the metal-air battery apparatus of claim 12, wherein the third operation is executed again when it is determined not to change the temperature of the at least one of the positive electrode and the negative electrode.
